(19) United States
(12) Patent Application Publication
(10) Pub. No.: US 2010/0088235 A1
(43) Pub. Date: Apr. 8, 2010

(54) SYSTEM AND METHOD FOR MEDIA CONTENT DISTRIBUTION

(75) Inventors: Keith Marshall Chatfield, Fort Collins, CO (US); Mark Alan Pastor, Erie, CO (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: Seagate Technology LLC, Scotts Valley, CA (US)

(21) Appl. No.: 12/244,052

(22) Filed: Oct. 2, 2008

(51) Int. Cl. H04L 9/00; G06Q 40/00

(52) U.S. Cl. 705/59; 705/51; 705/40; 705/39

(57) ABSTRACT

The present disclosure provides a system and method for media content distribution. In one exemplary embodiment, a method is provided and includes receiving a request from a user for a replacement copy of a specific media content. The request includes an indication from the user that they have an original copy of the specific media content. Media validation information is received from the user to validate the original copy of the specific media content. The replacement copy of the specific media content is provided to the user based on the media validation information. In one embodiment, providing the replacement copy of the specific media content to the user based on the media validation information comprises conditioning a payment action for the replacement copy based on the media validation information.

### BACKGROUND

The present disclosure relates generally to distribution of media content, and more specifically, but not by limitation, to a system and method for providing a media content exchange service.

Media content such as text, video content, and/or audio content are currently available to consumers in a variety of electronic formats. New formats continue to be developed to provide enhanced quality, compression capabilities, and data transfer rates, for example. Additionally, a significant portion of the media content that is purchased, transferred, sold and/or used by consumers comprises copyrighted material, or other licensed content, that is subject to restrictions such as licensing agreements relating to use, copying, and distribution of the media content. Electronic media can include copy protection and digital rights management (DRM) technology that prevents unauthorized use of the media content.

In some instances, a customer that possesses a copy of an electronic media content and/or a valid license for the content may be unable to view, listen to, or otherwise access their copy of the media content for a variety of reasons. For example, a customer may have purchased licensed content such as music, movies, books, artwork, video games, software, or other licensed content, that is incompatible with their current media storage device or media player. Some reasons for incompatibility include, but are not limited to, differences in electronic media types (e.g., tape, optical disk, network, vinyl records, etc.), differences in recording technologies or media formats (e.g., compact disc (CD), digital versatile disc (DVD), Blu-ray disk (BD), high-definition digital versatile disc (HD DVD)), differences in digital encoding rates, and/or incompatible digital rights management (DRM) technology, to name a few. Moreover, in many instances, the customer may not have the right to create a copy of the media content and/or the tools necessary to convert their copy to a compatible format. Purchasing a duplicate copy of the content in a compatible form is not desirable to the customer as they already have a copy of the content. Further, the customer may not be able to replace or exchange their incompatible copies with a compatible copy. For instance, a store or kiosk that sold the content to the customer may not accept an exchange of content with the customer. An exchange that requires physical transfer of the content also requires transit time and prevents use of the content by the customer for period of time.

The discussion above is merely provided for general background information and is not intended to be used as an aid in determining the scope of the claimed subject matter.

### SUMMARY

The present disclosure provides a system and method for media content distribution. In one exemplary embodiment, a method is provided and includes receiving a request from a user for a replacement copy of a specific media content. The request includes an indication from the user that they have an original copy of the specific media content. Media validation information is received from the user to validate the original copy of the specific media content. The replacement copy of the specific media content is provided to the user based on the media validation information. In one embodiment, providing the replacement copy of the specific media content to the user based on the media validation information comprises conditioning a payment action for the replacement copy based on the media validation information.

In another exemplary embodiment, a method is provided and includes receiving, at a content provider, a request for a specific media content from a customer. The request identifies a replacement copy of the specific media content and includes an indication from the customer that they have an original copy of the specific media content. The replacement copy is provided to the customer over a data network in response to the request. Media validation information is received to validate the original copy and the customer's access to the original copy is disabled. A payment action is conditioned between the customer and the content provider based on the step of disabling.

These and various other features and advantages will be apparent from a reading of the following Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a diagram illustrating a system for providing media content.

FIG. 2 is a flow diagram of a method for providing media content to a customer.

FIG. 3 is a flow diagram illustrating a method for initiating a content exchange transaction with a customer.

FIG. 4 is a flow diagram illustrating a method for initiating a content exchange transaction with a customer.

### DETAILED DESCRIPTION OF ILLUSTRATIVE EMBODIMENTS

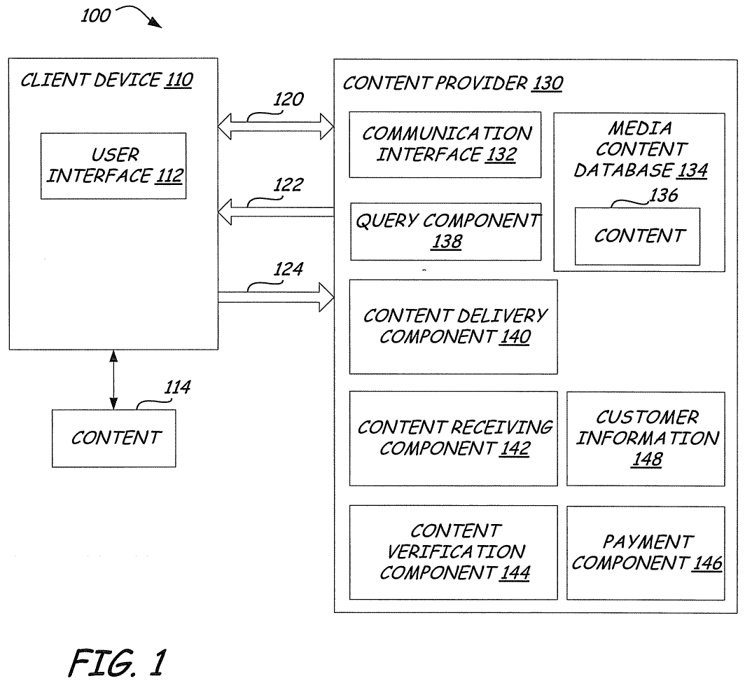

FIG. 1 is a diagram of a system for distributing electronic media content. As illustrated in FIG. 1, a client device 110 is configured to communicate with a content provider 130 over a communication channel 120. In one embodiment, client device 110 includes a computing device configured to communicate with content provider 130 over a network, such as the Internet. Communication channel 120 can comprise a network such as an intranet, a personal area network (PAN), a local area network (LAN), wide area network (WAN), and/or a global area network (GAN). Further, in one embodiment client device 110 and content provider 130 are configured in a server-client or peer-peer architecture. Examples of communication channels include wired connections (e.g., Ethernet, telephone networks, cable networks, fiber-optic networks, and the like), and wireless connections (e.g., wireless LAN, Wi-Fi, Bluetooth communication, radio communication, telecommunication, and the like). It is noted that these are examples of communication channels and are not intended to limit the scope of the concepts described herein.

As illustrated in FIG. 1, a user or customer at client device 110 has a copy 114 of electronic media content for which the customer desires an exchange transaction to replace the customer's copy 114. Copy 114 comprises media content stored on any type of electronic media and includes content stored on physical media and digital files stored in electronic databases, such as a data storage component of client device 110. An electronic media comprises media that utilizes electronics or electromechanical energy for an end user to access the content stored on the media. Types of electronic media include, but are not limited to, optical discs, magnetic discs, solid state storage devices (e.g., flash memory devices, random access memory (RAM), Static RAM, Dynamic RAM)), magnetic tapes, gramophone records (i.e., vinyl records), and magneto-optical discs, to name a few. Further, the content stored on the electronic media can be either digital or analog, and can be stored in any format. Examples of formats of electronic media content include, but are not limited to, video home system (VHS), Betamax, compact disc digital audio CDDA, digital versatile disc (DVD), Blu-ray disc (BD), high-definition digital versatile disc (HD DVD), MPEG Audio Layer 3 (MP3), Advanced Audio Coding (AAC), MPEG-4, Windows Media Audio (WMA), to name a few.

In one instance, the customer's copy 114 is incompatible with the customer's media storage device or media player. Examples of media storage devices and/or media players include computing devices, personal computers, laptop computers, video cassette recorders (VCR), digital music players, digital video recorders, DVD players, CD players, and radio communication devices, to name a few. Further, the customer's copy 114 can be incompatible for any of a variety of reasons including, but not limited to, differences in media types, differences in data formats (e.g., different digital encoding rates, different recording technologies), differences in physical interfaces, and/or incompatible digital rights management (DRM) technology. In the illustrated embodiment, the customer's copy 114 is an original copy of a specific media content that was purchased or otherwise obtained by the customer. The customer has a valid license to the content and rights to access, use, distribute and/or sell the content. Examples of a specific media content include, but are not limited to, text, images, audio content (e.g., music, stories, lectures, books on tape), and/or video content (e.g., video recordings, multimedia presentations, movies, theatrical performances, etc.). Further, the specific media content can also include computer files, computer programs, video games, and the like. It is noted that these are examples of specific media content for which a user possesses a copy 114, and is not intended to limit the scope of the concepts described herein.

Content provider 130 includes a media database 134 that contains a plurality of media items. The media items are copies of electronic media content and can include physical copies of media content as well as digital files stored in an electronic database. The media content stored in database 134 can include any electronic media type, format, and content, such as those discussed above. Further, for each specific media content stored in the database 134, the specific media content can be provided in multiple formats, DRMs, or content protection schemes, and/or on multiple types of electronic media. For example, copies of a specific movie are provided in database 134 on magnetic tapes, optical discs, magnetic discs, and solid state storage devices and are provided in VHS, DVD, Blu-Ray, and/or HD-DVD formats.

In the illustrated embodiment, database 134 includes a copy 136 of media content that corresponds to the user's copy 114. In this manner, copies of content 114 and 136 are copies of the same or substantially similar media content (e.g., movie, song, album, record, etc.). The copy 136 stored in database 134 is referred to herein as a “replacement copy” 136. Replacement copy 136 represents a copy of the specific media content, corresponding to copy 114, that is compatible with the customer's media storage device or media player. Copies 114 and 136 can comprise content stored on different or the same types of electronic media. Further, copies 114 and 136 can comprise content stored in different or the same data format.

In the illustrated embodiment, the customer's copy 114 of content includes copyrighted materials, or other materials subject to licensing agreements and/or restrictions pertaining to use of the content. Further, copy 114 can include associated media validation information. As used herein, media validation information refers to information indicative of the authenticity and validity of the media content. For instance, media validation information can be used to verify that the copy 114 of content is an original copy and/or that the copy 114 was previously purchased by the customer. Further, media validation information can indicate that the customer has rights to access, use, distribute, and/or sell copy 114. Examples of media validation information include, but are not limited to, proof of purchase information, sales receipts, and encoded identification information (e.g., digital signatures, metadata) included in the media content. Further, the media validation information can also include visual validation information provided on a physical copy of media content. In either case, the media validation information can be utilized to validate that copy 114 comprises valid, licensed content and/or that the customer purchased or otherwise properly acquired the copy 114 of media content in a manner in accordance with any legal or licensing requirements for the copy 114 of media content.

In the illustrated embodiment, content provider 130 comprises a plurality of program modules that are implemented within a computing environment. For example, as illustrated content provider 130 includes a server computing system operating in a network environment that utilizes connections to one or more remote computing devices, such as client device 110. The program modules implemented within content provider 130 can comprise storage devices, such as data storage drives and/or external memory devices that include computer-readable media providing non-volatile storage for storing computer-executable instructions and computer-readable data structures. In the embodiment illustrated in FIG. 1, content provider 130 includes a number of program modules that are stored in drives and/or random access memory (RAM). For example, the program modules can include modules 132-148, an operating system, and/or other program modules and program data.

Client device 110 includes any suitable computing device for communicating with content provider 130 including, but not limited to, a personal computer, laptop computer, mobile device, radio communication device, mobile phone, personal data assistant (PDA), and/or digital music player.

Content provider 130 includes a communication interface 132 for communicating with client device 110 over communication channel 120. For example, in one embodiment communication interface 132 is a Web application that is accessible over communication channel 120 via a web browser operating on computing device 110. Through communication interface 132, a customer at client device 110 utilizes an interface 112 to communicate with and access media content provided at content provider 130. For instance, the customer can request a content exchange transaction and can indicate a requested media content from the content provider 130. In one embodiment, the indication identifies the type and format of the requested replacement copy 136 of content and can include an assertion by the customer that the customer has an original or valid copy 114 of content that corresponds to the same or substantially similar media content as replacement copy 136.

Content provider 130 includes a query component 138 that is configured to archive, access, search, and retrieve content from database 134. For example, query component 138 receives the user request from interface 132 identifying a specific media content with identification information (e.g., title, album, artist, composer, format type, DRM information, etc.) and retrieves the corresponding content from database 134. The content retrieved by component 138 can comprise either physical copies of the content (e.g., movie content stored on an optical disc) or digital files stored in an electronic database.

Content provider 130 includes a content delivery component 140 configured to transmit the replacement copy 136 of media content from content provider 130 to the customer at client device 110. For example, content delivery component 140 can transmit (i.e., download) the replacement copy 136 to client device 110 through a data network, such as channel 120 (e.g., the Internet). In another embodiment, content delivery component 140 includes business and infrastructure components for transferring the replacement copy 136 through a physical distribution channel 122 to the customer. This can include shipping a physical copy of the media content to the customer.

Further, the content delivery component 140 can include downloadable client software to enable the client device 110 (e.g., the customer's computer) to download, unlock, and/or play the media content from database 134. Further yet, the replacement copy 136 of content can be provided with copy protection and/or digital rights management (DRM) technology to control use of replacement copy 136 by limiting access, copying, or conversion by end users. For example, digital rights management (DRM) technology can operate to prevent access to the replacement copy 136 of content by end users other than the customer that acquires the content from the content provider 130. Further, digital watermarks and/or metadata can also be included within the replacement copy 136 of content to contain information such as copyright owner, distributor, purchaser of the content, distribution chain, as well as information about the media content including author, artist, composer, album, title, etc.

Content provider 130 also includes a content receiving component 142 that is configured to receive content from the customer at client device 110. The content receiving component 142 is configured to receive physical copies of the content (e.g., movie content stored on an optical disc), digital files transferred through an electronic network, such as the Internet, or both physical and digital copies, for example. The customer's copy 114 (i.e., the “replaced copy” 114) can be transmitted through a physical distribution channel 124 and received at the content provider 130. In another example, the replaced copy 114, or a digital signature thereof, is transmitted over network 120 to content provider 130.

A content verification component 144 is configured to receive media validation information associated with replaced copy 114. For example, content verification component 144 can verify that replaced copy 114 is an original copy, a copy of previously purchased content and/or that the customer has, or had, a valid license for the replaced copy 114. Some examples of media validation information are discussed above. Media content information can be received from the customer and/or can be received from a third party, such as a vendor or retailer. For instance, a retailer can provide information to content provider 130 to indicate that the customer's copy 114 was purchased by the customer.

In one embodiment, content verification component 144 is also configured to verify that the replaced copy 114 is incompatible with the customer's media storage device or media player. In this manner, in addition to requesting a content exchange service, the customer can be required to provide at least some proof that the replaced copy 114 is in fact incompatible. This can be done manually or automatically within system 100. For example, in one embodiment content verification component 144 can be configured to communicate with client device 100 to obtain information pertaining to the customer's copy 114 and/or the customer's media storage device or media player. In another example, the customer can provide information to the content provider 130 to indicate that the customer's copy 114 is incompatible.

Content provider 130 also includes a payment component 146 that is configured to initiate payment actions between the customer and the content provider 130. In one embodiment, payment component 146 is configured to generate and send fee requests for payment to the customer and receive payments from the customer. This can include accepting and carrying out payments involving credit cards and/or bank information. Further, payment component 146 can be configured to provide payments, such as refunds, to the customer. Payment component 146 is also configured to utilize stored customer information 148 to perform payment actions. Stored customer information 148 includes information for identifying a customer and for keeping transaction records. Customer information 148 includes customer identification information such as a user name and password, a user name and address, shipping information, billing information, an IP address of the customer's computer (e.g., media format and type preferences), information regarding the configuration of the customer's computer, and records regarding the customer's previous transactions with the content provider 130.

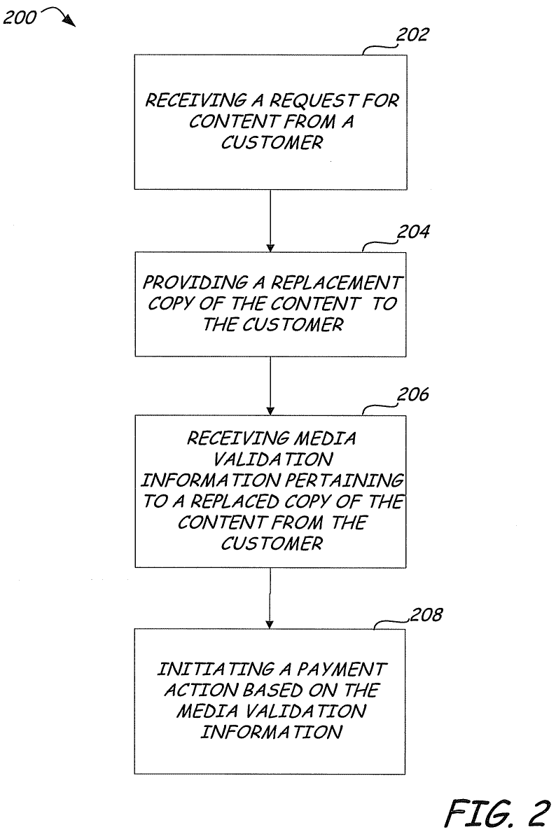

Using system 100, a customer initiates a transaction with content provider 130 for receiving a copy of media content. FIG. 2 is a flow diagram illustrating one embodiment of a method 200 for distributing content to a customer using system 100. At step 202, a request from the customer is received by the content provider 130. The request identifies a replacement copy 136 of a specific media content and includes an indication from the customer that they have an original and/or valid copy (i.e., copy 114) of the specific media content. In one embodiment of step 202, the customer is required to pay a transaction fee for the media exchange service and/or make a payment to the content provider 130 for the replacement copy 136.

At step 204, in response to the request for content and/or a fee payment by the customer at step 202, the replacement copy 136 of content is provided to the customer. In one example, the replacement copy 136 is immediately downloaded to the client device 110 via network 120. In another example, a physical copy of the content is transmitted through a physical distribution channel 122.

Further, method 200 includes receiving media validation information to validate the customer's replaced copy 114. This is indicated by block 206. In the illustrated embodiment, the media validation information is utilized to determine whether the replaced copy 114 was previously purchased by the customer, whether the user has a valid license for the replaced copy 114, and/or whether the customer has rights to use, distribute, and/or sell the replaced copy 114. In accordance with one embodiment, step 206 includes obtaining information to validate the customer's copy of content by requiring presentation and/or proof of content in some form by delivery of the content from the customer to the content provider.

In the illustrated embodiment of method 200, at least one aspect of providing the replacement copy 136 of content to the user is based on the media validation information received at step 206. This includes transferring the replacement copy 136 and/or initiating a payment action for the replacement copy 136 based on the media validation information. It is noted that the replacement copy 136 of content can be provided to the customer at step 204 either before, after, or simultaneously with receiving the media validation information from the customer at step 206. For instance, in the embodiment illustrated in FIG. 2 the customer requests a replacement copy 136 of the content and receives an immediate download of the replacement copy 136 of content. In this manner, the customer receives the replacement copy 136 before the customer provides the media validation information to the content provider 130. Alternatively, or in addition, method 200 can include providing the replacement copy 136 of content in response to media validation information received from the customer. For example, the replacement copy 136 is provided to the customer after media validation information is received from the customer that indicates that the customer's replaced copy 114 is an original copy of the content and/or the user possesses a valid license for the replaced copy 114.

As illustrated in FIG. 2, providing the replacement copy 136 of content to the customer includes initiating a payment action at step 208 between the customer and the content provider based on the media validation information received at step 206. The payment action includes, for example, a transaction fee request to the customer for the content exchange service, a payment request to the customer for the replacement copy 136, and/or a refund payment to the customer corresponding to a payment that the customer made for the replacement copy 136.

In one embodiment of method 200, the customer pays for the replacement copy 136 before the replacement copy 136 is transmitted to the customer. In this embodiment, step 208 comprises initiating a refund payment to the customer for the replacement copy 136 if the media validation information for the replaced copy 114 at step 206 indicates that the customer has a valid license for the replaced copy, the customer has rights to the replaced copy, the replaced copy was previously purchased, and/or the replaced copy was previously purchased by the customer. Further, the payment action at step 208 can be conditioned upon whether the replaced copy 114 was received from the customer within a prescribed period of time. For instance, in one embodiment a refund payment is not made to the customer if the replaced copy is not provided to the content provider within the predefined time period. The predefined time period is established before the replacement copy of the content is provided to the customer. For example, the customer can be required to enter into an agreement at step 202 that defines the period of time for providing the replaced copy 114 to the content provider 130.

In another embodiment of method 200, the customer does not pay a fee for the replacement copy 136, or pays only a transactional fee, before the replacement copy 136 is transmitted to the customer. In this embodiment, initiating a payment action at step 208 comprises requesting a fee from the customer for the replacement copy 136 if the replaced copy 114 is not provided to the content provider 130 within a prescribed time and/or media validation information is not received to validate the replaced copy 114.

In the embodiment illustrated in FIG. 2, method 200 includes one or more monetary transactions. For example, the customer is required to make a payment for the replacement copy 136 of content and/or pay a transactional fee. In another example, a refund payment is made to the customer. Alternatively, or in addition, method 200 can also include one or more non-monetary transactions. For instance, the content provider 130 may not accept monetary payments and/or can accept other forms of compensation for the replacement copy 136 of content. In one example, the content provider 130 acquires, in return for the replacement copy 136, a right to market products to the customer in the future. In other examples, a non-monetary transaction includes establishing an account relationship between the customer and the content provider 130 and/or accepting another copy of content from the customer as payment for the replacement copy 136, to name a few.

Embodiments described with respect to FIG. 2 enable a customer to receive a replacement copy for an incompatible copy of media content in a timely and efficient manner. In this manner, the customer can be provided virtually uninterrupted use of the media content without requiring the customer to purchase multiple copies of the media content or create new unpurchased copies of the media content. In contrast to conventional methods, a customer can obtain a replacement copy of incompatible media content without being required to purchase an additional copy and without being required to wait for transit time for returning the customer's incompatible copy.

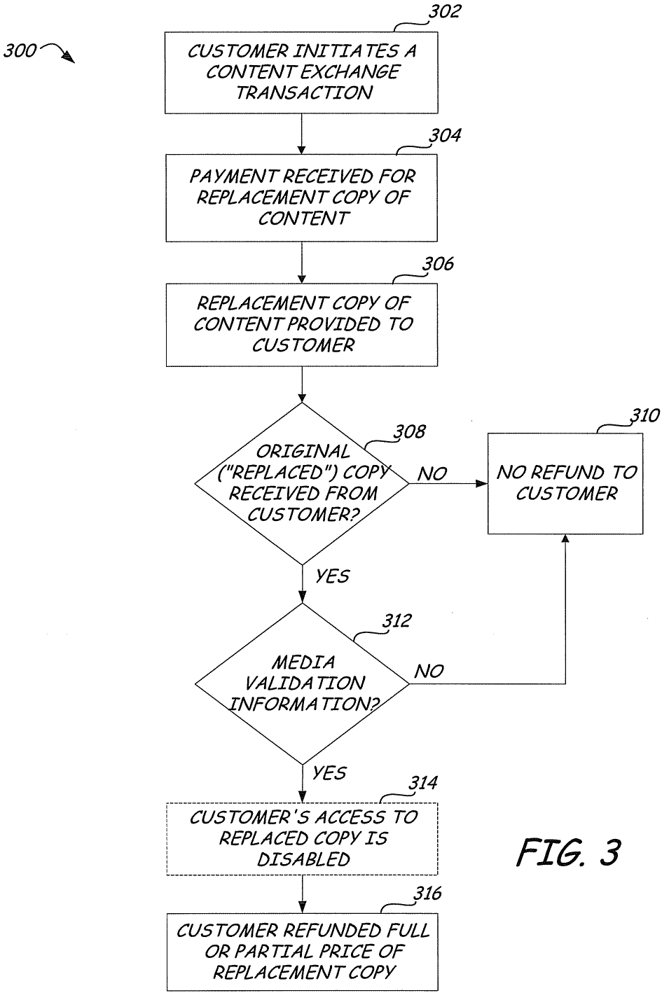

FIG. 3 is a flow diagram illustrating another embodiment of a method 300 for performing a content exchange transaction with a customer using system 100. At step 302, the customer initiates a content exchange transaction which includes, in one embodiment, receiving a request from the customer at the content provider 130 that identifies a replacement copy 136 of a specific media content for which the customer desires an exchange of content. The request can also include an indication or assertion from the customer that they possess an original and/or valid copy of the specific media content to be replaced (i.e., replaced copy 114). In the embodiment illustrated in FIG. 3, prior to receiving the replacement copy 136, payment is received from the customer for the replacement copy 136 of the specific media content. The payment received at step 304 corresponds to a full or partial retail price for the replacement copy 136 and/or a transaction fee for the content exchange transaction. In one embodiment of step 304, the customer enters into a content exchange agreement with content provider 130. The agreement can include payment information from the customer, such as credit card information, and an indication from the content provider 130 that a refund will be provided to the customer if the customer provides the replaced copy 114 of content within a prescribed period of time. The agreement can also include terms relating to a refund payment to the customer to be made at step 316, discussed below.

After the payment is received, the replacement copy 136 is provided to the customer at step 306. Step 306 includes, for example, transmitting (i.e., downloading) the replacement copy 136 of the content from the content provider 130 to the customer's media storage device or media player. For example, in the context of FIG. 1, the replacement copy 136 is transmitted from content provider 130 to client device 110 over communication channel 120, such as the Internet. Alternatively, or in addition, step 306 can include sending a physical copy of the media content to the customer through a physical distribution channel 122.

At step 308, the method determines whether the replaced copy 114 of the media content has been received from the customer. This can include receiving a physical copy of media content or receiving an electronic copy (or signature thereof) over an electronic network. In one embodiment, step 308 determines whether the replaced copy has been received from the customer within a prescribed time. The prescribed time is set during initiation of the content exchange transaction. For example, the customer can agree at step 302 to provide his/her copy 114 of the content to the content provider 130 within the prescribed time. If the copy 114 is not received from the customer at step 308, no refund is provided to the customer for the payment received at step 304. This is indicated by block 310.

At step 312, the method checks media validation information associated with the replaced copy received from the customer. Examples of media validation information are described above. The media validation information to utilized, for example, to determine whether the replaced copy 114 was previously purchased, was previously purchased by the customer, and/or whether the customer has rights (i.e., use, sale, distribution) for the replaced copy 114. If no media validation information is received or the media validation information does not indicate that the replaced copy is a valid copy of content, no refund is provided to the customer (block 310).

In the embodiment illustrated in FIG. 2, method 200 includes an optional step 314 wherein the customer's access to the replaced copy 114 is disabled, indefinitely or for a prescribed period of time, for example. In one embodiment, step 314 comprises logging, storing, and/or destroying the replaced copy 114. Further, step 314 can include electronically disabling the customer's replaced copy 114, such as by using digital rights management technology, or the like, to prevent the user from further access and use of the replaced copy. In any case, step 314 disables use of the customer's replaced copy 114, which can be either a physical copy of the media content or an electronic copy stored in an electronic database such as client device 110.

In one embodiment of step 314, the replaced copy 114 is kept by the content provider 130 for a prescribed period of time. Thereafter, the replaced copy is returned to the customer thereby restoring the user's access of the replaced copy. In one embodiment, the period of time that the replaced copy 114 is held by the content provider 130 is such that it ensures that the replaced copy 114 is not a “rental” copy that the customer acquired from a rental store. This can operate to prevent activities such as the “rent, rip, and return” of media content where rented media content is copied illegally to make an unpurchased copy of content.

At step 316, a refund payment is initiated with the customer and is conditioned on the media validation information and/or the step of disabling the customer's access to the replaced copy at step 314. The refund payment can correspond to a full or partial price for the replaced copy that was provided by the customer at step 304. In this manner, a refund payment is made to the customer if the media validation information indicates that the replaced copy 114 is a valid copy of content and the customer's access to the replaced copy 114 has been disabled.

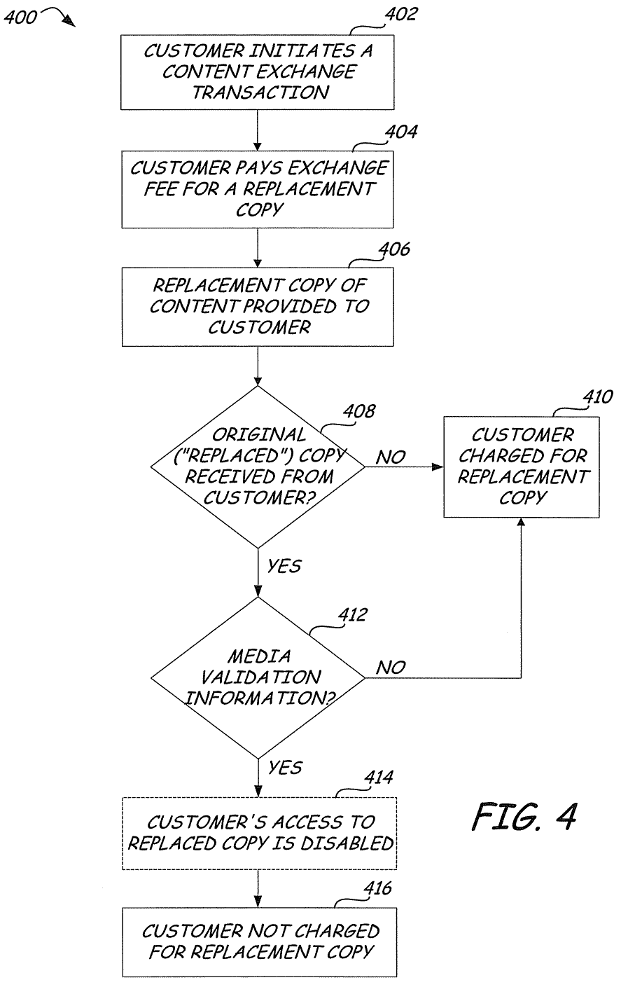

FIG. 4 is a flow diagram illustrating one embodiment of a method 400 for providing a content exchange transaction with a customer. At step 402, the customer initiates a content exchange transaction. Illustratively, step 402 is similar to step 302 described with respect to FIG. 3. A request is received that identifies a specific media content and a particular format for which the customer desires a replacement copy 136 of content. Further, the request can include an indication or assertion that the customer has an original copy (i.e., replaced copy 114) of the specific media content. In method 400, the customer agrees to provide the replaced copy 114 of the content to the content provider 130 within a prescribed time or be charged full (or partial) retail price for the replacement copy 136. In this manner, the customer does not pay for the replacement copy 136 prior to the replacement copy 136 being provided to the customer. In one embodiment of method 400, at step 402 the customer enters into an agreement with content provider 130 in which the customer agrees to provide the replaced copy 114 to the content provider 130 within a prescribed period of time and provides payment information in case the replaced copy 114 is not received by the content provider 130 within the prescribed period of time. The payment information can include credit card information, bank information, and/or stored customer information 148. As illustrated in FIG. 4, method 400 includes an optional step 404 wherein the customer pays an exchange transaction fee for the content exchange transaction.

At step 406, the replacement copy 136 of the content is provided to the customer and, at step 408, the method determines whether the replaced copy 114 is received from the customer. In the illustrated embodiment, steps 406 and 408 are illustratively similar to steps 306 and 308, illustrated in FIG. 3. If the replaced copy 114 is not received at step 408, or is not received within a prescribed time, the customer is charged for the replacement copy 136 at step 410. For instance, credit card information and/or bank information that was previously provided by the customer can be utilized to charge the customer for the replacement copy 136.

At step 412, media validation information for the replaced copy 114 is checked. If media validation information is not received, or the media validation information indicates that the replaced copy 114 is not a valid copy, the customer is charged for the replacement copy at step 410. At step 414, the customer's access to the replaced copy 114 is disabled. In the illustrated embodiment, step 414 is similar to step 314, described with respect to FIG. 3. At step 416, based on the media validation information and/or the step of disabling the customer's access to the replaced copy 114, the customer is not charged for the replacement copy. In one embodiment of step 416, the customer is charged a transaction fee and/or a portion of the replacement copy 136. For instance, the customer can be charged an upgrade fee if the replacement copy 136 is an upgrade from the replaced copy 114.

It is to be understood that even though numerous characteristics and advantages of various embodiments of the invention have been set forth in the foregoing description, together with details of the structure and function of various embodiments of the disclosure, this disclosure is illustrative only, and changes may be made in detail, especially in matters of structure and arrangement of parts within the principles of the present disclosure to the full extent indicated by the broad general meaning of the terms in which the appended claims are expressed. For example, the particular elements may vary depending on the particular application for the system or method while maintaining substantially the same functionality without departing from the scope and spirit of the present disclosure and/or the appended claims.

What is claimed is:

1. A method comprising:
receiving a request from a user for a replacement copy of a specific media content, the request including an indication from the user that the user has an original copy of the specific media content;
receiving media validation information from the user to validate the original copy of the specific media content; and
providing the replacement copy of the specific media content to the user based on the media validation information.

2. The method of claim 1, wherein receiving media validation information comprises verifying that the specific media content was previously purchased by the user.

3. The method of claim 1, wherein receiving media validation information comprises verifying that the user has a valid license for the original copy of the specific media content.

4. The method of claim 1, wherein the replacement copy of the specific media content is transmitted to the user in response to a first payment received from the user for the replacement copy, and wherein providing the replacement copy of the specific media content to the user based on the media validation information comprises:
conditioning a payment action with the user based on the media validation information, wherein the payment action includes a refund payment corresponding to at least a portion of the first payment received from the user.

5. The method of claim 4, wherein transmitting the replacement copy comprises transmitting the replacement copy to the user before the media validation information is received.

6. The method of claim 5, wherein transmitting the replacement copy comprises transmitting the replacement copy to the user over an electronic network before the media validation information is received.

7. The method of claim 4, wherein receiving media validation information from the user to validate the original copy of the specific media content comprises:
determining that the user has a valid license for the original copy of the specific media content; and
disabling the user's access to the original copy of the specific media content, wherein the refund payment is provided to the user in response to the steps of determining and disabling.

8. The method of claim 1, wherein the request and the media validation information are received from the user at a content provider, and wherein the replacement copy of the specific media content is transmitted from the content provider to the user in response to the request, wherein providing the replacement copy of the specific media content to the user based on the media validation information comprises:
conditioning a payment action between the user and the content provider based on the media validation information.

9. The method of claim 8, wherein the replacement copy is transmitted from the content provider to the user before the media validation information is received at the content provider, and wherein conditioning a payment action comprises:
requesting a fee payment from the user if the media validation information is not received from the user within a pre-determined period of time.

10. The method of claim 8, wherein the replacement copy is transmitted from the content provider to the user before the media validation information is received at the content provider, and wherein conditioning a payment action comprises:
requesting a fee payment from the user if the media validation information indicates that the user does not have a valid license for the original copy of the specific media content.

11. The method of claim 8, wherein conditioning a payment action between the user and the content provider comprises providing a refund payment to the user that corresponds to a payment received from the user for the replacement copy.

12. The method of claim 1, wherein receiving the request from the user comprises receiving an indication from the user that the original copy of the specific media content is incompatible with a media player used by the user to access media content, and wherein the method further comprises:
verifying that the original copy is incompatible with the media player, wherein the replacement copy is provided to the user based on the verifying step.

13. A method comprising:
receiving, at a content provider, a request for a specific media content from a user, wherein the request identifies a replacement copy of the specific media content and includes an indication from the user that the user has an original copy of the specific media content;
providing the replacement copy to the user over a data network in response to the request;
receiving media validation information to validate the original copy of the media content;
disabling the user's access to the original copy; and
conditioning a payment action between the user and the content provider, wherein the payment action is conditioned on the media validation information and the step of disabling.

14. The method of claim 13, wherein receiving media validation information comprises determining whether the user has a valid license for the original copy of the specific media content, and wherein the payment action is conditioned on whether the user has a valid license for the original copy.

15. The method of claim 14, wherein the replacement copy is provided to the user over the data network before the step of receiving media validation information.

16. The method of claim 15, wherein providing the replacement copy includes receiving a first payment from the user for the replacement copy and wherein conditioning a payment action comprises providing a refund payment to the user based on the media validation information, the refund payment corresponding to at least a portion of the first payment.

17. The method of claim 15, wherein receiving media validation information comprises receiving the original copy from the user and wherein conditioning a payment action comprises requesting a fee from the user for the replacement copy if the media validation information indicates that the user does not have a valid license for the original copy.

18. A system for providing media content, the system comprising:
a media content database including a plurality of media items;
a communication interface configured to receive a request from a user for a specific media content, wherein the request identifies a media item in the database corresponding to a specific media content, and wherein the request includes an indication that the user has a copy of the specific media content;
a content delivery component configured to transmit the media item from the database to the user;
a content verification component configured to validate the copy of the specific media content, wherein the system is configured to disable the user's access to the copy of the specific media content; and
a payment component configured to initiate a payment action with the user based on the media validation information, wherein the payment component is configured to condition the payment action with the user based on whether the user's access to the copy is disabled.

19. The system of claim 18, wherein the payment component is configured to receive a fee for the media item and the content delivery component is configured to transmit the media item to the user based on the fee, wherein the payment action is a refund payment to the user based on the fee.

20. The system of claim 18, wherein the payment component is configured to request a payment from the user for the media item if the copy of the specific media content is not received from the user within a prescribed time or the media validation information indicates that the user does not have a valid license for the copy.
